(19) United States
(12) Patent Application Publication
(10) Pub. No.: US 2013/0039720 A1
(43) Pub. Date: Feb. 14, 2013

(54) SCREW

(71) Applicant: Sheng-Tsai SHIH, Kaohsiung City (TW)

(72) Inventor: Sheng-Tsai SHIH, Kaohsiung City (TW)

(21) Appl. No.: 13/207,845

(22) Filed: Aug. 11, 2011

(51) Int. Cl. F16B 25/10

(52) U.S. Cl. 411/387.4

(57) ABSTRACT

A screw comprises a head and a rod extended downward from the head. The rod has a tip at a distal end and a round thread spirally extended upward from the tip. The round thread is an asymmetric thread and has serrated cutting edges extended upward from the tip and formed along a circumference in a desired distance. The rod also has a cutting thread with a plurality of spiral cutting edges spirally extended upward from the tip in the same spiral direction as that of the round thread. When the screw is screwed into a workpiece, the asymmetric thread can effectively reduce resistance of screwing. Further, the serrated cutting edges and the cutting thread of the invention can increase the cutting effect. Thereby, the screw of the invention enables the user to fasten workpieces faster with less effort.

### FIELD OF THE INVENTION

The present invention relates to a screw, particularly to an improved screw structure having an asymmetric thread with serrated cutting edges and a cutting thread.

### BACKGROUND OF THE INVENTION

Screws are widely used to fasten wooden workpieces and plastic workpieces. A screw normally has a thread spirally formed around a rod, and the rod has a tip at the front end to pierce into a workpiece, and then the spiral thread is screwed into the workpiece for fastening.

As the thread of the screw is formed in a round shape, when the screw is screwed into the workpiece, the thread is contact with the workpiece in a line or surface. Thus, the screw encounters greater friction between the screw and the workpiece. Consequently, the user has to spend more time and effort fastening workpieces. The fastening effect suffers. Therefore, the conventional technology needs improving.

### SUMMARY OF THE INVENTION

In view of the disadvantages in the conventional screw structure, the present invention proposes a screw, which is easy to operate and labor-saving, and can prevent workpieces from cracking.

The present invention proposes a screw, which comprises a head and a rod extended from the head and having a tip at the distal end thereof The rod has a round thread spirally formed thereon and extended upward from the tip. The round thread is an asymmetric thread and has serrated cutting edges extended from the tip and formed along the circumference in a desired distance. The rod also has a cutting thread with a plurality of spiral cutting edges extended upward from the tip in the same spiral direction as that of the round thread. The spiral cutting edges respectively have a spiral angle steeper than that of the round thread and intersect the round thread by at least two thread pitches. The cutting thread has an outer diameter smaller than that of the round thread.

The present invention has following advantages:

1. As the round thread has the serrated cutting edges, they can destroy fibers of the workpieces faster when the screw of the invention is screwed into and thus reduces the working hours.

2. The cutting thread of the invention can improve the cutting effect, reduce resistance of screwing, and prevent workpieces from cracking when the screw of the invention is screwed into the workpieces.

3. As the round thread of the invention is an asymmetric thread, it reduces the contact area between the screw and the workpiece, decreases the friction of screwing, and increases the working efficiency when the screw of the invention is screwed into the workpieces.

### BRIEF DESCRIPTION OF THE DRAWINGS

FIG. 1 is a perspective view schematically showing a screw according to one embodiment of the present invention;

FIG. 2A is a front view of FIG. 1;

FIG. 2B is a sectional view taken on Line 2B-2B in FIG. 2A; and

FIG. 2C is a locally enlarged view of the asymmetric thread in FIG. 2A.

### DETAILED DESCRIPTION OF THE PREFERRED EMBODIMENTS

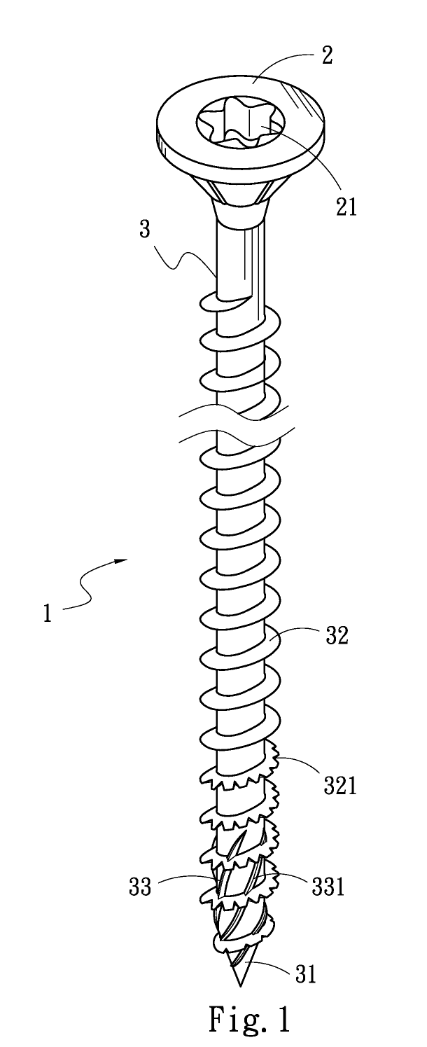

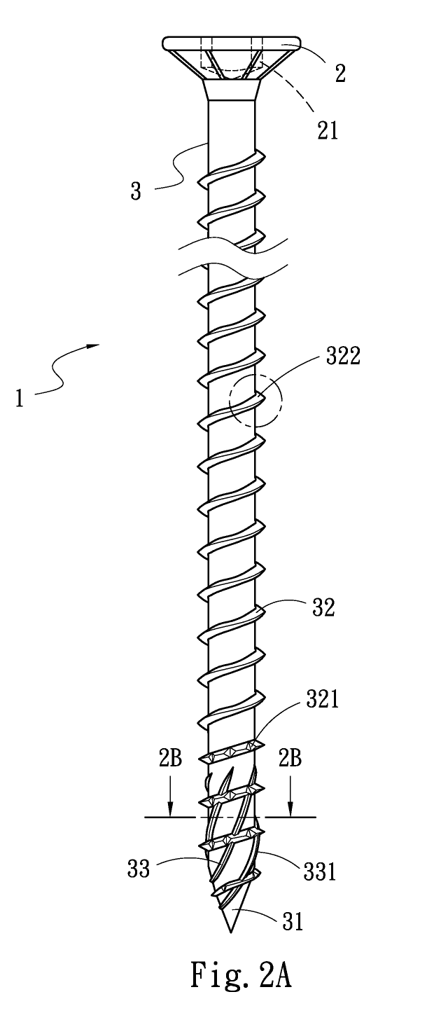

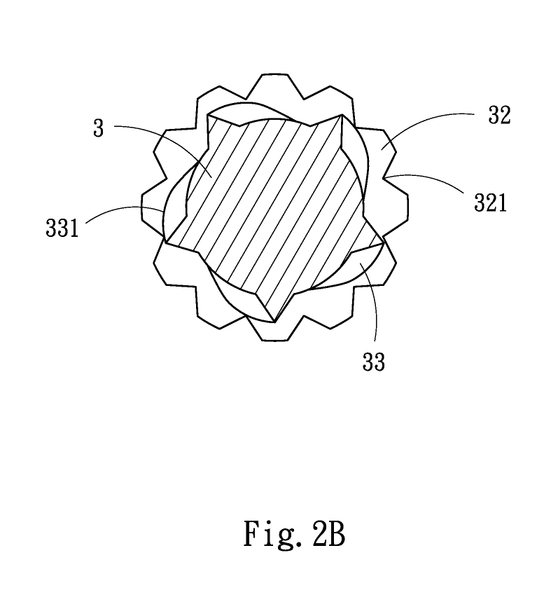

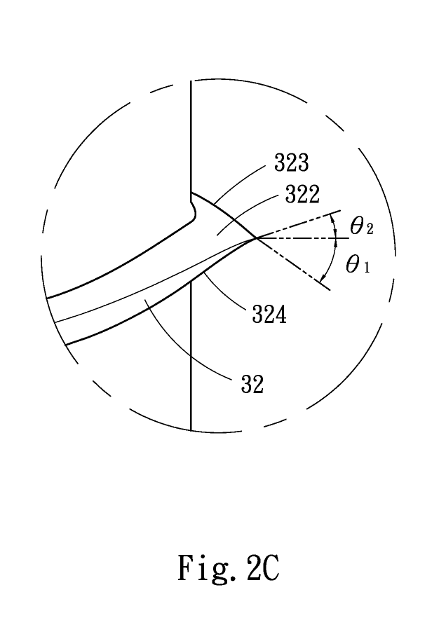

Refer to FIG. 1, FIG. 2A and FIG. 2B. The present invention proposes a screw 1 comprising a head 2 and a rod 3.

The head 2 has a wrench notch 21 at the top to be wrenched by a screwdriver.

The rod 3 is extended downward from the head 2 and has a tip 31 at the distal end thereof. The rod 3 is a cylinder-like one. The rod 3 has a round thread 32 spirally extended upward from the tip 31. The round thread 32 is an asymmetric thread. The round thread 32 has serrated cutting edges 321 extended from the tip 31 and formed along the circumference in a desired distance so as to reduce friction during screwing of the screw 1. The rod 3 also has a cutting thread 33 with a plurality of spiral cutting edges 331 extended upward from the tip 31 in the same spiral direction as that of the round thread 32. The spiral cutting edges 331 respectively have a spiral angle steeper than that of the round thread 32 and intersect the round thread 32 by at least two thread pitches. The cutting thread 33 has an outer diameter smaller than that of the round thread 32 so as to increase the cutting effect, reduce the friction of screwing and prevent the workpiece from cracking when the screw 1 is screwed into the workpieces.

Refer to FIG. 2A and FIG. 2C. The asymmetry thread refers to the fact that the cutting edge 322 of the round thread 32 has a first cutting face 323 forming a first angle θ₁ with respect to the horizontal plane and a second cutting face 324 forming a second angle θ₂ with respect to the horizontal plane. The first angle θ₁ is not equiangular to the second angle θ₂. The first angle θ₁ is preferably 30 degrees, and the second angle θ₂ is preferably 10 degrees.

During operation of the screw 1, the user uses the tip 31 of the rod 3 to pierce into the workpiece and engages the screwdriver in the wrench notch 21 of the head 2. Next, the user wrenches the screwdriver to screw the tip 31 into the workpiece. Thus, a hole is formed in the workpiece. At the same time, the cutting thread 33 begins to cut the workpiece to reduce the friction of screwing of the round thread 32. Further, the serrated cutting edges 321 of the round thread 32 increases the speed of destroying the fibers of the workpiece. Furthermore, the asymmetric thread enables the user to screw the screw 1 faster with less effort.

What is claimed is:

1. A screw, comprising:
a head including a wrench notch at the top to be wrenched by a screwdriver; and
a cylinder rod which is extended from the head, including a tip at a distal end and a round thread spirally extended upward from the tip, the round thread being an asymmetry thread and including serrated cutting edges extended from the tip and formed along a circumference in a desired distance, the rod further including a cutting thread with a plurality of spiral cutting edges extended upward from the tip in the same spiral direction as that of the round thread, wherein the spiral cutting edges respectively have a spiral angle steeper than that of the round thread and intersect the round thread by at least two thread pitches, and wherein the cutting thread has an outer diameter smaller than that of the round thread.

2. The screw according to claim 1, wherein the asymmetric thread includes a first angle of 30 degrees and a second angle of 10 degrees.
